(19) United States
(12) Patent Application Publication
(10) Pub. No.: US 2026/0278367 A1
(43) Pub. Date: Sep. 17, 2026

(54) DEVICE AND METHOD FOR ADAPTIVE BRAIN-INSPIRED MEMORY BASED CONTINUAL LEARNING

(71) Applicant: ELECTRONICS AND TELECOMMUNICATIONS RESEARCH INSTITUTE, Daejeon (KR)

(72) Inventors: Jung Hoon LEE, Daejeon (KR); Cheol Ho KIM, Daejeon (KR); Hyun Woo KIM, Daejeon (KR); Hwa Jeon SONG, Daejeon (KR); Young Hwan SHIN, Daejeon (KR); Jeong Min YANG, Daejeon (KR); Byung Hyun YOO, Daejeon (KR); Eui Sok CHUNG, Daejeon (KR)

(21) Appl. No.: 19/450,504

(22) Filed: Jan. 15, 2026

(30) Foreign Application Priority Data
Jan. 17, 2025 (KR) 10-2025-0007095

(51) Int. Cl. G06N 3/08

(52) U.S. Cl. CPC G06N 3/08

(57) ABSTRACT

The adaptive brain-inspired memory-based continual learning method and device may include a brain-inspired memory unit including an episodic memory unit and a semantic memory unit, an artificial intelligence model unit that directly learns and updates input data, a task change analysis unit that detects a time point when a task of the input data is changed and analyzes a level of the change, an adaptive multi-layer knowledge distillation unit that distills knowledge stored in the brain-inspired memory unit and reflects the same on the update of the artificial intelligence model unit, and an adaptive memory update unit that reflects the updated artificial intelligence model unit on the brain-inspired memory unit when the update of the artificial intelligence model unit is completed.

### CROSS-REFERENCE TO RELATED APPLICATION(S)

This application claims the benefit of earlier filing date and right of priority to Korean Application No. 10-2025-0007095, filed on Jan. 17, 2025, the content of which is hereby incorporated by reference herein in its entirety.

### BACKGROUND

### 1. Technical Field

The present disclosure relates to a continual learning technology that may efficiently form and utilize memory in a situation where various tasks must be continuously learned to continuously accumulate knowledge without forgetting the existing knowledge.

### 2. Description of Related Art

Unlike the general artificial intelligence technology field intended to improve performance by learning one data set, continual learning may be intended to improve overall performance by continuously learning multiple data sets. For example, a model learning global climate data needs to continuously learn climate data that is constantly generated over time.

This continual learning technology is extensively studied particularly in relation to the deep learning technology. It is because although a deep learning model may improve performance with more data, the phenomenon of excessively losing knowledge about previously learned data when learning new data, which is called catastrophic forgetting, frequently occurs compared to other algorithms. In addition, since the learning cost of a deep learning model is higher than that of other algorithms, it is highly inefficient to newly learn data which is newly acquired by being combined with the existing data in order to prevent this forgetting phenomenon.

### SUMMARY OF THE INVENTION

The key to memory-based continual learning which is effective in solving catastrophic forgetting, a chronic problem in continual learning, is to construct a memory which may help alleviate forgetting and has a low load. To this end, the present disclosure proposes a method for adaptively forming and utilizing a semantic memory unit at the time point of learning new knowledge. The present disclosure is to provide a model that efficiently and continuously learns various tasks and obtain good performance based on a brain-inspired memory through this.

The adaptive brain-inspired memory-based continual learning method and device of the present disclosure may include a brain-inspired memory unit including an episodic memory unit and a semantic memory unit, an artificial intelligence model unit that directly learns and updates input data, a task change analysis unit that detects a time point when a task of the input data is changed and analyzes a level of the change, an adaptive multi-layer knowledge distillation unit that distills knowledge stored in the brain-inspired memory unit and reflects the same on the update of the artificial intelligence model unit, and an adaptive memory update unit that reflects the updated artificial intelligence model unit on the brain-inspired memory unit when the update of the artificial intelligence model unit is completed.

In the adaptive brain-inspired memory-based continual learning method and device of the present disclosure, the episodic memory unit may adaptively store the input data based on the maximum number of data that may be stored by the episodic memory unit.

In the adaptive brain-inspired memory-based continual learning method and device of the present disclosure, in response to a case where the number of the input data is less than or equal to the maximum number of data, the input data may be sequentially stored in the episodic memory unit.

In the adaptive brain-inspired memory-based continual learning method and device of the present disclosure, in response to a case where the number of the input data is greater than the maximum number of data, only when an integer extracted as a random integer function is a value less than the maximum number of data, an instance of the episodic memory unit corresponding to the integer may be replaced with the input data.

In the adaptive brain-inspired memory-based continual learning method and device of the present disclosure, the semantic memory unit may have a model of the same structure and size as the artificial intelligence model unit.

In the adaptive brain-inspired memory-based continual learning method and device of the present disclosure, the artificial intelligence model unit may include ResNet.

In the adaptive brain-inspired memory-based continual learning method and device of the present disclosure, analyzing the level of the change may be performed by quantifying a knowledge difference between tasks based on a distance between prototypes per class in an embedding space.

In the adaptive brain-inspired memory-based continual learning method and device of the present disclosure, reflection on the brain-inspired memory unit may be performed by adjusting a probability of updating the artificial intelligence model unit to the semantic memory unit of the brain-inspired memory.

In the adaptive brain-inspired memory-based continual learning method and device of the present disclosure, the probability may be determined based on a probability that a task is changed and a level of a change.

In the adaptive brain-inspired memory-based continual learning method and device of the present disclosure, reflecting the update of the artificial intelligence model unit may be performed based on a normalized loss function.

In the adaptive brain-inspired memory-based continual learning method and device of the present disclosure, the normalization may be performed by using a coefficient that is directly proportional to a probability that a task is changed and a level of a change.

### BRIEF DESCRIPTION OF DRAWINGS

FIG. 1 illustrates a brain-inspired memory unit.

FIG. 2 illustrates an adaptive brain-inspired memory-based continual learning device.

FIG. 3 illustrates a task change analysis unit.

FIG. 4 illustrates an adaptive memory update concept diagram.

FIG. 5 illustrates an adaptive multi-layer knowledge distillation unit.

FIG. 6 illustrates an adaptive brain-inspired memory-based continual learning method.

### DETAILED DESCRIPTION OF THE INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention. In the drawings, similar reference numerals are used to designate the same or similar functions in various aspects. The shapes, sizes, etc. of components in the drawings may be exaggerated to make the description clear. Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as

### Long As They Are Appropriately Described.

Terms such as “first” and “second” may be used to describe various components, but the components are not restricted by the terms. The terms are used only to distinguish one component from other components. For example, the first component may be named the second component without departing from the scope of the right of the present disclosure and likewise, the second component may be named the first component. The terms “and/or” may include combinations of a plurality of related described items or any of a plurality of related described items.

It will be understood that when a component in the present disclosure is referred to as being “connected” or “coupled” to another component, it may be directly connected or coupled to such another component, but another component also may exist in the middle. On the other hand, it will be understood that when a component is referred to as being “directly connected or coupled”, another component does not exist in the middle.

As construction units shown in an embodiment of the present disclosure are independently shown to represent different characteristic functions, it does not mean that each construction unit is composed in a construction unit of separate hardware or one software. In other words, construction units are included by being arranged as a construction unit for convenience of a description, and at least two of the construction units may be integrated into one construction unit, or one construction unit may be divided into a plurality of construction units to perform a functions, and the integrated embodiment and the separated embodiment of each construction unit are also included in the scope of the right of the present disclosure as long as they do not depart from the essence of the present disclosure.

The terms used in the present disclosure are merely used to describe specific embodiments, and are not intended to limit the present disclosure. A singular expression includes a plural expression unless the context clearly indicates otherwise. In the present disclosure, it should be understood that terms such as “include” or “have” are merely intended to indicate that features, numbers, steps, operations, components, parts described herein or combinations thereof are present, and are not intended to exclude the possibility in advance that one or more other features, numbers, steps, operations, components, parts or combinations thereof are present or added. In other words, a description of “including” a specific configuration does not exclude a configuration other than a corresponding configuration, and means that an additional configuration may be included in the scope of the technical idea of the present disclosure or the embodiment of the present disclosure.

Some components of the present disclosure are not an essential component for performing an essential function in the present disclosure, but may be merely an optional component for improving performance. The present disclosure may be implemented by including only construction units essential for implementing the essence of the present disclosure excluding components used only for performance improvement, and a structure including only essential components excluding optional components used only for performance improvement is also included in the scope of the right of the present disclosure.

Hereinafter, the embodiments of the present disclosure will be described in detail below by referring to drawings. In describing the embodiments of the present disclosure, when it is determined that a specific description for related known configurations or functions may obscure the gist of the present disclosure, that detailed description is omitted, and the same reference numerals are used for the same components on drawings and a repeated description for the same components is omitted.

A deep learning continual learning technique may typically include a normalization-based technique, a model expansion-based technique and a memory-based technique.

The key to a normalization technique may be to prevent a previously important weight from being greatly changed by adding a normalization term to a weight or a loss function to protect the existing knowledge. It may be highly efficient since it has a low additional resource load and may be directly applied to most models. However, it has relatively low extendibility, so its effect of improving forgetting may be small in continuous continual learning.

A model extension-based technique is a method for extending a model whenever new knowledge is needed, which reduces versatility because it has a high resource load as stability is high and requires an additional condition to recognize new knowledge.

Lastly, a memory-based technique, just like the name, may be a method for storing a part of data or knowledge learned in a previous task in a memory and utilizing it for learning again. When it is used by limiting a memory size, it may obtain relatively stable performance even under limited resources and have high extendibility. In addition, it may be universally used in a variety of situations because it does not need an additional condition.

A human brain may have a remarkable ability to preserve the existing knowledge even when performing various tasks consecutively. It stems from various functions of a brain, but among them, the importance of a ‘memory’ mechanism is known to be particularly important. A memory mechanism described here is composed of various elements, but may mainly refer to an episodic memory and a semantic memory that take charge of a part of long-term memory.

An episodic memory is a memory which is mainly stored in the hippocampus, which may be a memory about a specific event or situation experienced by an individual.

A semantic memory is a memory which is mainly stored in the cerebral cortex, which may be a memory about general knowledge, concepts, languages, facts, etc.

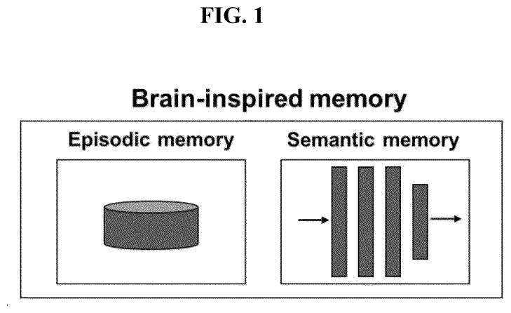

FIG. 1 illustrates a brain-inspired memory unit.

A brain-inspired memory may be a memory module that inspires the hippocampus and the cerebral cortex, respectively, to inspire an episodic memory and a semantic memory which are two key elements of a brain's memory mechanism mentioned above.

The hippocampus may be inspired as a memory storing an instance itself by interpreting a specific event or situation as an individual instance, and the cerebral cortex may be inspired as an artificial intelligence model by interpreting comprehensive and holistic knowledge that exists separately regardless of this event or situation as an artificial intelligence model. Hereinafter, these two memory components may be collectively referred to as a brain-inspired memory.

A brain-inspired memory must be continuously updated during learning, and this process may be referred to as brain-inspired memory formation. The process of alleviating forgetting of previous knowledge by appropriately utilizing this formed memory when learning a new task may be referred to as utilizing a brain-inspired memory.

As an example, since the episodic memory unit of a brain-inspired memory typically stores an instance itself, a method for determining the maximum number of storable instances, sampling a part of continuously incoming data and probabilistically replacing a previously stored instance may be used. In this case, it may be important to form and utilize a semantic memory unit better than an episodic memory unit.

As an embodiment, a method for utilizing two artificial intelligence models in charge of a semantic memory together may be proposed. Here, two artificial intelligence models are referred to as a plastic model and a stable model, respectively, and update a model at different speed like their names, and accordingly, a plastic model may be intended to update new knowledge more quickly and a stable model may be intended to update new knowledge relatively slowly.

The models may generate a plastic or stable model by applying an exponential moving average (EMA) to the weight of a working model participating in learning. Logits distillation, a type of knowledge distillation technique, may be used to utilize this.

As an embodiment, a pre-learned model generated in advance through other data may be used as a semantic memory, which may be utilized by applying feature distillation, a type of knowledge distillation technique. In this case, feature information may be selected and utilized through an attention module to more harmoniously use the information of multiple layers.

As an embodiment, a method for inheriting and utilizing an EMA-based semantic memory may be improved. The learning phases of a working model may be divided into retention and promotion, and it is possible to focus on determining a part of a working model to be focused during retention and find a part to be forgotten during promotion. In other words, a model may be differentiated and utilized according to a task.

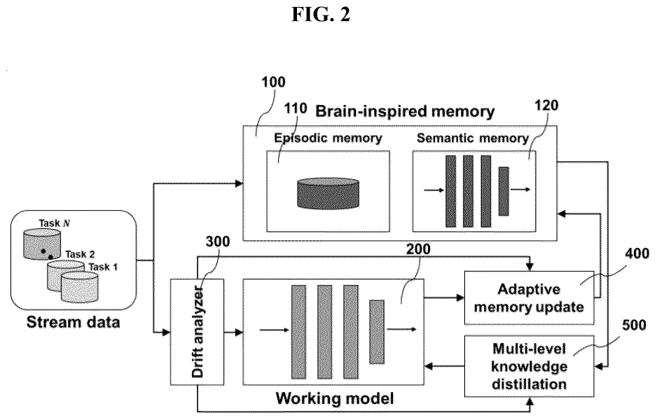

FIG. 2 illustrates an adaptive brain-inspired memory-based continual learning device.

Referring to FIG. 2, a device for continuously learning various tasks based on the adaptive brain-inspired memory of the present disclosure may include a task change analysis unit 300 for forming and utilizing an adaptive brain-inspired memory, an adaptive memory update unit 400 and an adaptive multi-layer knowledge distillation unit 500 other than a brain-inspired memory unit 100 and an artificial intelligence model unit 200 that directly learns data.

Before describing main modules in detail, the overall learning flow is summarized as follows for the smoother understanding of the technical contents.

First, input data may come in sequentially, not at once, as shown in the leftmost of FIG. 2.

In addition, each task data may be input by being divided into at least one dataset. In other words, the present disclosure may be a universal method that may range from online learning where an instance is input one by one to a general continual learning setting input in the unit of a task.

In the present disclosure, a class-incremental learning situation where data called CIFAR 10 consisting of 10 classes is divided into five tasks and each task learns all classes sequentially by including two classes is used as an example of the invention.

The data incoming in this way may be input to the brain-inspired memory 100 and the artificial intelligence model for learning 200. In this case, data heading towards an artificial intelligence model unit may be first input to a task change analysis unit 300, and a task change analysis unit 300 may analyze whether data drift or concept drift occurs in input data and if so, its level and deliver them to an adaptive memory update unit 400 and an adaptive multi-layer knowledge distillation unit 500. Afterwards, an artificial intelligence model unit 200 may distill knowledge stored in a memory through an adaptive multi-layer knowledge distillation unit 500 to reflect it on the update of a model (an artificial intelligence model) simultaneously with learning input data. When an artificial intelligence model unit is updated once in this way, it may be reflected on the brain-inspired memory through an adaptive memory update unit 400.

### Brain-Inspired Memory Unit 100

A brain-inspired memory unit 100 may be divided into an episodic memory unit 110 and a semantic memory unit 120 that inspire the human hippocampus.

First, an episodic memory unit samples and stores a part of input data, and as a specific sampling method, various methods may be selected, but in the present disclosure, the generally known reservoir sampling may be described as an example. This method may ultimately aim to ensure that a probability of being stored in an episodic memory unit is the same in each instance.

Specifically, when the maximum number of data that may be stored in an episodic memory unit is B and the total number of input data is N, if B>N, newly incoming data may be sequentially added to an episodic memory unit, and if B≤N, one integer v may be extracted by v=randomInteger (min=0, max=N), and only if v<B, the v-th instance stored may be replaced with newly incoming data.

A semantic memory unit may average the weights of an artificial intelligence model unit through Exponential Moving Average (EMA) to generate a new model and utilize it as a semantic memory unit. As a result, a semantic memory unit may be considered as an artificial intelligence model that does not directly participate in learning, but has the same structure and size as an artificial intelligence model unit.

The semantic memory unit of the present disclosure is composed of one EMA-type model, and a probability of performing EMA is not fixed to one value, but may be adjusted through a task change analysis unit 300 and an adaptive memory update unit 400.

### Artificial Intelligence Model Unit 200

An artificial intelligence model (or model unit) may represent a model that directly learns input data. For example, ResNet may be used to classify CIFAR10 image data, and this ResNet may correspond to an artificial intelligence model unit. However, since the elemental technology of the present disclosure does not require an additional condition for the artificial intelligence model unit, other artificial intelligence models such as MLP, transformer, etc. may also be utilized.

It should be additionally mentioned that the artificial intelligence model unit may not know the order of a task to which currently input data belongs and may also not utilize task information for learning.

In FIG. 2, input data is clearly divided for each task for intuition, but under a real situation, it is often impossible to know the order of a task to which input data belongs, so the artificial intelligence model unit may learn input data regardless of task information for versatility. Instead, the task change analysis unit, the adaptive memory update unit based thereon and the adaptive multi-layer knowledge distillation unit may take charge of adaptability required according to a task change.

### Task Change Analysis Unit 300

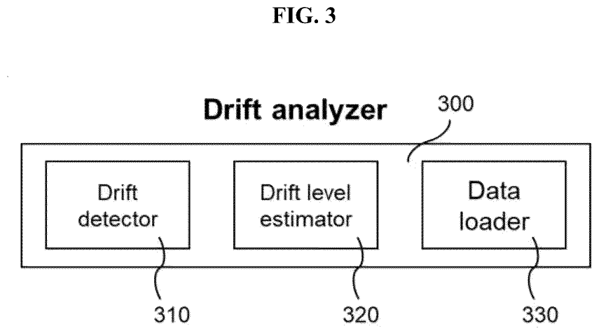

FIG. 3 illustrates a task change analysis unit.

The task change analysis unit may help adjust a model to avoid forgetting a past class while adapting to a new class by detecting a time point when the task of input data is changed, i.e., a time point when a data distribution is changed, and its level.

The task change analysis unit may include the task change detection unit 310, the task change level measurement unit 320 and the data delivery unit 330.

For this purpose, the task change detection unit 310 first detects a time point when a task is changed. A specific method may vary depending on the nature of a task. In case of class-incremental learning which is used as an example in the present disclosure, it may be detected that a task is changed when an instance belonging to a new class is added to the episodic memory unit. In contrast, in case of domain-incremental learning, an additional means is required because it is difficult to know that a domain is changed even with class information, but it may be detected that a domain is changed when embedding is formed at a place far from the existing embedding cluster through an embedding network. In addition, a change may be detected even with a sudden decrease in the prediction confidence of a model. When an external module is utilized, ADWIN (Adaptive Windowing) or GMM (Gaussian Mixture Models), etc. may be utilized. Since the present disclosure deals with class-incremental learning, other methods are not described in detail.

The task change level measurement unit 320 may quantify a difference between the existing knowledge and newly learned knowledge when it is detected that a task is changed.

It may be because if knowledge learned in Task 2 is significantly different from that in Task 1, it needs to prevent forgetting of Task 1 by actively utilizing a memory while actively learning Task 2 and if knowledge learned in Task 2 is similar to that in Task 1, it needs to focus on distinguishing between Task 1 and Task 2.

There are various methods for quantifying a knowledge difference between these tasks, but for real-time adaptability, the present disclosure may perform quantization through a distance between prototypes per class in an embedding space. A part of the artificial intelligence model unit may be utilized as an embedding network to obtain representative embedding representing each class in an embedding space, i.e., a prototype, and use a distance between prototypes as a type of knowledge difference index.

Finally, the data delivery unit 330 of the task change analysis unit may modify the order of input data as needed and deliver it to a learning model. For example, when data is mixed between tasks, it may be partitioned in the unit of a task and delivered to an artificial intelligence model, reducing learning difficulty.

### Adaptive Memory Update Unit 400

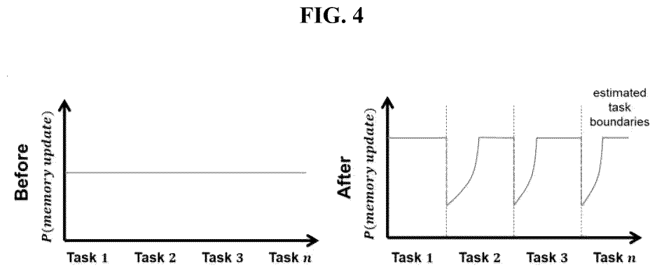

FIG. 4 illustrates an adaptive memory update concept diagram.

When the artificial intelligence model unit is updated, the adaptive memory update unit 400 may reflect it on a brain-inspired memory.

A corresponding module may adjust the probability P_{EMA} of updating the artificial intelligence model unit to the semantic memory unit. probability P_{change} that a task is changed and change level level_{change} may be delivered from the task change analysis unit 300 at every iteration.

Since probability P_{change} that a task is changed and change level level_{change} may be delivered from the task change analysis unit 300 at every iteration, the probability P_{EMA} of updating the artificial intelligence model unit to the semantic memory unit may be determined as follows. P′_{EMA} is a preset hyperparameter, which may refer to the maximum P_{EMA}.

$${P}_{EMA} = {P}_{EMA}^{′} f ( {P}_{change} , {level}_{change} )$$

As P_{EMA} is lower, the existing knowledge is utilized, so P_{EMA} may be inversely proportional to P_{change}, level_{change}. FIG. 4 may visualize an example in which P_{EMA} is adjusted according to a task change.

### Adaptive Multi-layer Knowledge Distillation Unit 500

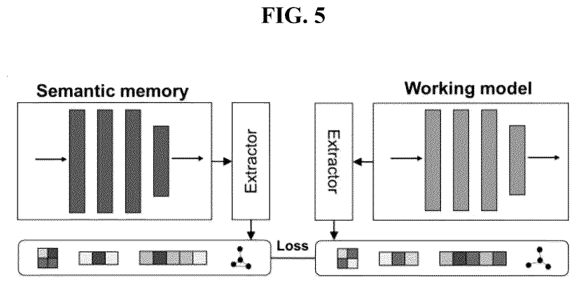

FIG. 5 illustrates an adaptive multi-layer knowledge distillation unit.

Since a semantic memory unit is formed to have the same model structure as an artificial intelligence model unit, information about a past task stored in a semantic memory unit may be utilized in an artificial intelligence model unit that learns a current task by utilizing a generally known knowledge distillation method.

However, in the present disclosure, unlike the existing method for utilizing only partial information, as shown in FIG. 5, the same input may be given to each model, a model's response thereto, the activation value of intermediate layers, a final output logits value, a mutual distance between multiple instances, etc. may be extracted and normalized and a loss function may be comprehensively defined and utilized. In addition, this loss function may be multiplied by coefficient a and reflected on the update of an artificial intelligence model as a normalization term.

Coefficient a is not a fixed value like P_{EMA} in an adaptive model update unit, but may be adjusted in real time as a function for P_{change}, level_{change} as follows. In this case, as a is larger, a memory is actively utilized, so P_{change}, level_{change} may be directly proportional to a.

$$a = g ( {P}_{change} , {level}_{change} ) \\ L = {L}_{sup} + a \cdot {L}_{distill}$$

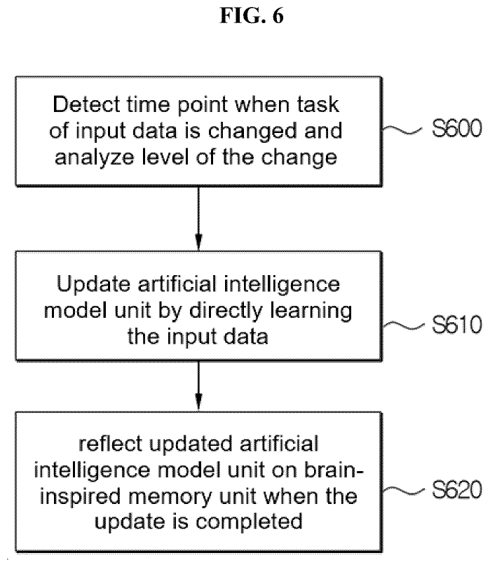

FIG. 6 illustrates an adaptive brain-inspired memory-based continual learning method.

The adaptive brain-inspired memory-based continual learning method of the present disclosure may include detecting a time point when the task of input data is changed and analyzing the level of the change; directly learning the input data to update an artificial intelligence model unit; and reflecting an updated artificial intelligence model unit on a brain-inspired memory unit when the update is completed.

In this case, the update of the artificial intelligence model unit may be performed by reflecting distilled knowledge stored in the brain-inspired memory unit, and the brain-inspired memory unit may be characterized by including an episodic memory unit and a semantic memory unit.

Since the specific details of the adaptive brain-inspired memory-based continual learning method of the present disclosure are the same as the adaptive brain-inspired memory-based continual learning device of the present disclosure, specific details are omitted below.

A method according to an embodiment of the present disclosure may be implemented by a program which may be performed by a computer, and the computer program may be recorded in a variety of recording media such as a magnetic storage medium, an optical readout medium, a digital storage medium, etc.

A variety of technologies described in the present disclosure may be implemented by a digital electronic circuit, computer hardware, firmware, software or a combination thereof. The technologies may be implemented by a computer program product, i.e., a computer program tangibly implemented on an information medium or a computer program processed by a computer program (e.g., a machine readable storage device (e.g., a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language, and may be distributed in any form including a stand-alone program or module, a component, a sub-routine or other units suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and at least one processor of a digital computer. Generally, a processor receives an instruction and data in a read-only memory or a random access memory or both of them. The component of a computer may include at least one processor for executing an instruction and at least one memory device for storing an instruction and data. In addition, a computer may include at least one mass storage device for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, a ROM (Read Only Memory), a RAM (Random Access Memory), a flash memory, an EPROM (Erasable Programmable ROM), an EEPROM (Electrically Erasable Programmable ROM) and other known computer readable media. A processor and a memory may be complemented or integrated by a special-purpose logic circuit.

A processor may execute an operating system (OS) and at least one software application executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer, and may include both a computer storage medium and a transmission medium.

The present disclosure relates to a method for efficiently forming and utilizing a brain-inspired memory according to a task change to perform continual learning for various tasks. Unlike the existing technology that deals with a brain-inspired memory, but in forming it, uses a relatively simple method, for example, that a parameter related to the formation and utilization of a brain-inspired memory according to a task change is not changed, the present disclosure proposes a method for detecting the time point of a task change, quantifying a level thereof and reflecting it on the formation and utilization of a brain-inspired memory. This method enables the implementation of a more efficient and highly adaptive brain-inspired memory, enabling continual learning more efficiently under a situation where resources are limited, which may be utilized for smart factories, small robots, mobile terminal-based personalized services, etc. requiring continual learning for streaming data that is under an on-device situation where resources are insufficient and is continuously generated.

The present disclosure includes a detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination or the combination may be described as being initially claimed, but in some cases, at least one feature may be excluded from a claimed combination or a claimed combination may be changed in the form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments, and the above-described program component and device may be packaged into a single software product or multiple software products.

Illustrative embodiments disclosed herein are just illustrative and do not limit the scope of the present disclosure. Those skilled in the art may recognize that illustrative embodiments may be variously modified without departing from a claim and the spirit and scope of its equivalent.

Accordingly, it may be said that the present disclosure includes all other replacements, modifications and changes belonging to the following claims.

What is claimed is:

1. An adaptive brain-inspired memory-based continual learning device, comprising:
a brain-inspired memory unit including an episodic memory unit and a semantic memory unit;
an artificial intelligence model unit that directly learns and updates input data;
a task change analysis unit that detects a time point when a task of the input data is changed and analyzes a level of the change;
an adaptive multi-layer knowledge distillation unit that distills knowledge stored in the brain-inspired memory unit and reflects the same on the update of the artificial intelligence model unit; and
an adaptive memory update unit that when the update of the artificial intelligence model unit is completed, reflects the updated artificial intelligence model unit on the brain-inspired memory unit.

2. The device of claim 1, wherein the episodic memory unit adaptively stores the input data based on a maximum number of data that may be stored by the episodic memory unit.

3. The device of claim 2, wherein in response to a case where a number of the input data is less than or equal to the maximum number of data, the input data is sequentially stored in the episodic memory unit.

4. The device of claim 2, wherein in response to a case where a number of the input data is greater than the maximum number of data, only when an integer extracted as a random integer function is a value less than the maximum number of data, an instance of the episodic memory unit corresponding to the integer is replaced with the input data.

5. The device of claim 1, wherein the semantic memory unit has a model of a same structure and size as the artificial intelligence model unit.

6. The device of claim 1, wherein the artificial intelligence model unit includes ResNet.

7. The device of claim 1, wherein analyzing the level of the change is performed by quantifying a knowledge difference between tasks based on a distance between prototypes per class in an embedding space.

8. The device of claim 1, wherein reflection on the brain-inspired memory unit is performed by adjusting a probability of updating the artificial intelligence model unit to a semantic memory unit of the brain-inspired memory.

9. The device of claim 8, wherein the probability is determined based on a probability that a task is changed and a level of the change.

10. The device of claim 1, wherein reflecting the update of the artificial intelligence model unit is performed based on a normalized loss function.

11. The device of claim 10, wherein the normalization is performed by using a coefficient that is directly proportional to a probability that a task is changed and a level of the change.

12. An adaptive brain-inspired memory-based continual learning method, comprising:
detecting a time point when a task of input data is changed and analyzes a level of the change;
updating an artificial intelligence model unit by directly learning the input data; and
when the update is completed, reflecting the updated artificial intelligence model unit on a brain-inspired memory unit,
wherein an update of the artificial intelligence model unit is performed by reflecting distilled knowledge stored in the brain-inspired memory unit, and
wherein the brain-inspired memory unit includes an episodic memory unit and a semantic memory unit.

13. The method of claim 12, wherein the input data is adaptively stored in the episodic memory unit based on a maximum number of data that may be stored by the episodic memory unit.

14. The method of claim 13, wherein in response to a case where a number of the input data is less than or equal to the maximum number of data, the input data is sequentially stored in the episodic memory.

15. The method of claim 13, wherein in response to a case where a number of the input data is greater than the maximum number of data, only when an integer extracted as a random integer function is a value less than the maximum number of data, an instance of the episodic memory unit corresponding to the integer is replaced with the input data.

16. The method of claim 12, wherein the semantic memory unit has a model of a same structure and size as the artificial intelligence model unit.

17. The method of claim 12, wherein the artificial intelligence model unit includes ResNet.

18. The method of claim 12, wherein analyzing the level of the change is performed by quantifying a knowledge difference between tasks based on a distance between prototypes per class in an embedding space.

19. The method of claim 12, wherein reflecting the distilled knowledge stored in the brain-inspired memory unit is performed by adjusting a probability of updating the artificial intelligence model unit to a semantic memory unit of the brain-inspired memory.

20. The method of claim 19, wherein the probability is determined based on a probability that a task is changed and a level of the change.
